(19) United States
(12) Patent Application Publication
(10) Pub. No.: US 2013/0136562 A1
(43) Pub. Date: May 30, 2013

(54) METHOD FOR PRODUCING A PERSONALIZED STORYBOOK

(71) Applicant: Tana Fillingame, Vidor, TX (US)

(72) Inventor: Tana Fillingame, Vidor, TX (US)

(21) Appl. No.: 13/305,969

(22) Filed: Nov. 29, 2011

(51) Int. Cl. B42C 9/00

(52) U.S. Cl. 412/1

(57) ABSTRACT

A method of making a customizable storybook, including selecting a plot and a themed scene having a physical setting, selecting at least one character that relates to the plot, photographing a user at the physical setting, obtaining at least one photograph of the user at the physical setting, and combining the plot and the at least one photograph to produce a customized book.

### FIELD

The present invention is generally related to the manufacturing of books. More specifically, the present invention is related to the creation of personalized fictional storybooks.

### BACKGROUND

Photography has been a staple in modern times as a means for preserving memories of past events. Specifically, photography has long been used as a means to remember enjoyable events such as vacations and outings with loved ones, family members and friends. Photographs of these memories are usually arranged in the form of photo albums, scrapbooks, or, in recent times, some form of digital media.

In addition, recent times have seen a dramatic rise in the availability of digital cameras and other digital photography. The rapid rise of digital photography has led to new and unique ways to organizing and creating collages, scrapbooking and electronic photo albums. In addition, the use of word processing software and photo editing software has also allowed for the ability to cut, paste and alter photos to quickly and neatly fit within a document. Such a dynamic has allowed the rapid production, editing, and design of pictures, scrapbooks and photo albums. However, the creation of photo albums and photo editing usually takes place at home at some point after a vacation or family event has ended. This delay in creating a photo album such that the mood of the event is not as fresh on everyone's mind, may lead to a loss in creativity.

It would be desirable to combine the on-demand characteristics of digital media with the creation of photo albums to obtain an instantly available family keepsake. It would also be desirable to instantly capture the fun and memories of family photographs into a creative fictional storybook that is creative, instant, and unique.

### SUMMARY

An embodiment of the present invention is a method of making a book that includes selecting a plot and a themed scene that includes a physical setting, selecting a character that relates to the plot, photographing a user wearing a costume at the physical setting, obtaining at least one photograph of the user at the physical setting, and combining the plot and the at least one photograph to produce a book.

An alternate embodiment is a method of making a customizable book that includes having at least one user select a plot and at least one character that relates to the plot, photographing the at least one user at a physical setting that relates to the plot and the at least one character, and obtaining at least one photograph of the at least one user wearing a costume at the physical setting. The plot and the at least one photograph are combined to produce a customized book comprising text and the at least one photograph, where the text includes the plot.

An further embodiment of the invention is a method of conducting an interactive tour resulting in a customizable book. The method includes providing a plot and a physical setting, having at least one user select at least one character that relates to the plot, and having the at least one user wear a costume. The at least one user is guided through the physical setting and photographed at predetermined locations along the physical setting that relates to the plot and the at least one character. At least one photograph of the user at the physical setting is obtained and the plot and the at least one photograph are combined to produce a customized book having text and the at least one photograph, wherein the text comprises the plot.

### BRIEF DESCRIPTION OF DRAWINGS

FIG. 1 depicts a block flow diagram showing steps involved in selecting users depicted in a customized book.

FIG. 2 depicts a block flow diagram showing steps involved in producing a customized book.

### DETAILED DESCRIPTION

Disclosed herein is a method to produce a customizable book or pamphlet containing photographs. The customizable book may be obtained by selecting a storyline and character(s) from a set number of predefined storylines and characters. In an embodiment, the customizable book may be obtained by having a person, or persons, (referred to herein as “user(s)”) selecting characters, selecting a physical setting, selecting a plot or storyline, having at least a portion of the user(s) photographed as at least a portion of the selected characters at the physical setting, and finally combining the photographs with the storyline in the book. In another embodiment, a customizable book may be obtained by having user(s) select at least one of a plot or storyline, a physical setting, a character or characters. The user(s) may be character(s) that are photographed and/or mentioned in the plot or storyline of the customizable book.

The customizable book may be created on-site by input provided by user(s). In an embodiment, the user(s) may be portrayed as characters in the customizable book. In another embodiment, the user(s) may play characters in the customizable book. The user(s) may first select at least one of the character(s), storyline/plot, and the theme/setting in any desired order or sequence. In an embodiment, the user(s) are characters in the customizable book.

The user(s) may play an integral part of the storyline, which may involve their participation as character(s). The user(s) participation as a character may be accomplished by providing the user(s) with a costume and other accessories to dress for the chosen character(s), and then photographing the user(s) as they play the character(s) as portrayed in the customizable book. The final product is a customized book containing photographs of the user(s) in character. The placement of the photos in the customized book can follow the preset theme and storyline that the user(s) have chosen.

The characters may be created by the user(s). In an embodiment, the characters may be created on-site by the user(s). The characters may be selected from a defined preselect group of characters, for instance. In another embodiment, the user may create additional characters to supplement the defined listing of characters. Not all characters must be selected. In addition, multiple users may select the same character to portray in a single customized book. In an embodiment, multiple costumes may be mixed and matched in any arrangement to create a desired look by the user(s).

The characters may be photographed in a physical setting. The physical setting may accompany the theme or plot of the customized book. The physical setting, or themed scene, can include any backdrop, set, or stage that has a connection to the story, plot, or theme of the customized book. In addition, costumes, makeup, and the like, may be available at the physical setting. The costumes, make-up, and the like, may or may not have a theme consistent with the physical setting. In an embodiment, the costumes, make-up, and the like, must have a theme that coincides with the physical setting. In another embodiment, the costumes, make-up, and the like, coincide with a preselect group of characters that are consistent with the theme and physical setting.

For example, the physical setting can have a pirate theme, which can include a pirate's ship. The pirate themed physical setting may have a pirate's ship having a plank, which may be lowered to the floor for entrance onto the boat, a ship's wheel, and a working telescope, flag masts, a smoke ring shooting cannon, a treasure chest full of treasure, and the like. In an embodiment, the physical setting may also include added sound and visual effects. For example, the pirate theme may also include a remote controlled parrot that can be programmed to say specific words and phrases.

The user(s) may supply their own costumes for use in the photo shoot. In an embodiment, costumes may also be available at the physical setting. The user(s) may select any desired costume in which to appear in the customizable book. Make-up and other accessories may also be available at the physical setting so that the user(s) may fully create the desired characters. The physical setting may also contain dressing rooms for the user(s) to put on the costume(s) and other accessories. In an embodiment, the physical setting may contain a secret door entrance into the dressing rooms and a character creation workshop outside of the dressing rooms where make-up and other finishing touches may be applied. In an embodiment, the user(s) wear costume(s) that coincide with the theme and the physical setting. In an embodiment, the entrance into the dressing rooms may have a theme that is consistent and integrated with the physical setting.

After the user(s) select their desired costume(s), the user(s) may then choose to be photographed in their respective costume(s) at the physical setting. The photographing may be accomplished via a photo shoot of the user(s) in costume at the physical setting. The photo shoot can include a guided tour of the physical setting, or a series of photos taken at various locations at the physical setting.

The guided tour can include having the user(s) appear in costume at the physical setting, having the user(s) move in-person through at least a part of the physical setting, having a guide lead at least one of the user(s) through at least a part of the physical setting, and having the guide read at least some select excerpts of the script, or story, of the customized book, and photographing at least one of the user(s) at the physical setting. In an embodiment, the guide leads the user(s) through the entire physical setting. In a further embodiment, the guide can be a person. The user(s) may follow the guide through at least a part of the physical setting. In an even further embodiment, the guide can be an electronically controlled system of indicators and speakers that lead the user(s) through at least a portion of the physical setting. In an embodiment, the user(s) are photographed as they move through at least a portion of the physical setting.

In an embodiment, the user(s) may act out select scene(s) from the story or plot during the guided tour. The user(s) may also have their photographs taken as they act out the selected scene(s).

Returning to the pirate theme example, the photo shoot may include a guided tour of a pirate ship, wherein audio of a speaking narrator will guide the user(s) to predetermined sections of the boat. Photographs of at least one of the user(s) may be taken at these predetermined sections. These photographs may be posed pictures, photos capturing the user(s) natural curiosity of each scene and of the adventure in which they are participating, or a combination of the two. The final stop on the boat can be a treasure chest containing loose pieces that can be available for each user to collect a souvenir.

In an embodiment, the user(s) may personalize the scene to their liking. For example, the user(s) may decide to create a name for the pirate ship. The ship name may be created by having removable/reusable letters available at the physical setting to spell out a desired name and then placing the letters on the side of the boat.

The user(s) may obtain the customized book by inputting a desired character(s) into a system, inputting a desired plot or storyline into the system, and including placeholders for placing the photograph(s) of the user(s) taken during the guided tour. In an embodiment, the user(s) can then choose a prewritten storyline from a selection of storylines to create a storybook, or customizable book, using the pictures that were just taken during the guided tour. The user(s) names may be used in the text of the story. The final product, or customized book, may be obtained on-site of the physical setting and may be available after the conclusion of the guided tour.

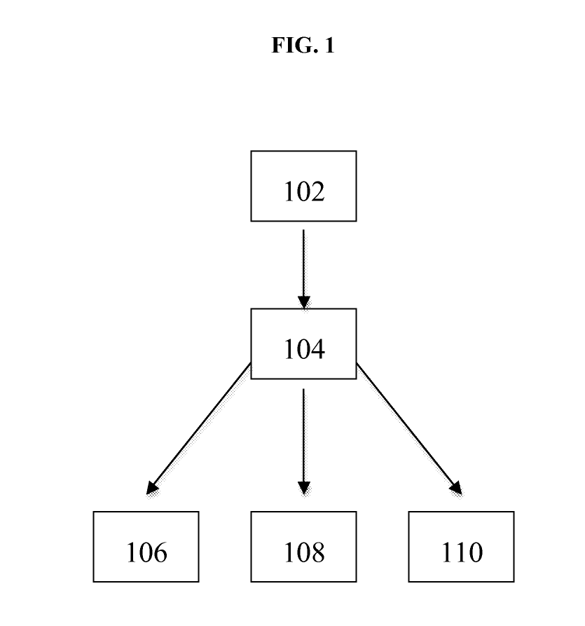

Turning now to FIG. 1, a flow sheet is depicted showing the steps of an embodiment having a user, or users, select a plot. As shown, in step 102, the user(s) are selected. In step 104, the selected user, or users, select how many of the selected user(s) will be photographed and thus included in the customized book. The user(s) may select a plot 106 if only one user elects to be photographed, plot 108 if two users elect to be photographed, or plot 110 if greater than two users elect to be photographed. In an embodiment, steps 102 and/or 104 may be conducted off-site or on-site of the physical setting (not shown). In another embodiment, steps 102-110 may be conducted off-site or on-site of the physical setting (not shown).

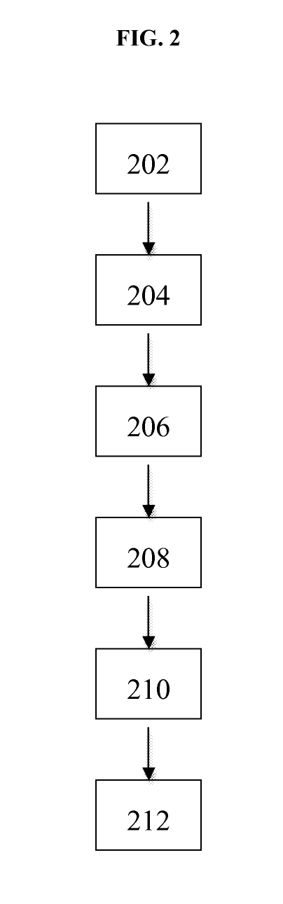

Turning now to FIG. 2, a flow sheet is provided showing the steps of an embodiment involved in a method for creating a customized book of the present invention. The first step, step 202 involves selecting or determining the number of person(s) to be included as user(s) and optionally which user(s) will be photographed. The next step, step 204 includes the step of selecting a plot. The following step, step 206 includes guiding the user(s) through a physical setting. During the guided tour step 206, the user(s) may be photographed randomly or at predetermined locations along the physical setting. Step 208 will include the selection of photos wherein each user may select which photos taken at the physical setting will be included in the customizable book. Step 210 may include having user(s) interact with a programmed computer, or other device, to obtain printable material for the customizable book by merging the selected photos with the text of the plot into desired locations within the customizable book. Photographs may be placed near areas of text describing or relating to each photograph. In an embodiment, the programmed computer may depict how the photos and text are to appear in the customizable book so that the user(s) may select or customize the arrangement of test and/or photographs to their liking. Step 210 may also include any further desired customization of the customizable book, such as text color, page color, binding materials, and any added artwork or pictures. Step 212 involves the printing and optional binding of the customized book from the printable material obtained from step 210.

It is to be understood that while illustrative embodiments have been depicted and described, modifications thereof can be made by one skilled in the art without departing from the spirit and scope of the disclosure. Use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, etc.

Depending on the context, all references herein to the “invention” may in some cases refer to certain specific embodiments only. In other cases it may refer to subject matter recited in one or more, but not necessarily all, of the claims. While the foregoing is directed to embodiments, versions and examples of the present invention, which are included to enable a person of ordinary skill in the art to make and use the inventions when the information in this patent is combined with available information and technology, the inventions are not limited to only these particular embodiments, versions and examples. Also, it is within the scope of this disclosure that the aspects and embodiments disclosed herein are usable and combinable with every other embodiment and/or aspect disclosed herein, and consequently, this disclosure is enabling for any and all combinations of the embodiments and/or aspects disclosed herein. Other and further embodiments, versions and examples of the invention may be devised without departing from the basic scope thereof and the scope thereof is determined by the claims that follow.

What is claimed is:

1. A method of making a book, comprising:
selecting a plot and a themed scene comprising a physical setting;
selecting a character that relates to the plot;
photographing a user at the physical setting;
obtaining at least one photograph of the user at the physical setting; and
combining the plot and the at least one photograph to produce a book;
wherein the user wears a costume.

2. The method of claim 1, wherein the user is wearing a costume representing the character.

3. The method of claim 1, wherein the user selects the character.

4. The method of claim 1, wherein the user selects the plot.

5. The method of claim 1, wherein the user selects the physical setting.

6. The method of claim 1, wherein the plot, the character, and the themed scene all relate to each other.

7. The method of claim 1, further comprising photographing multiple users at the physical setting and obtaining at least one photograph of each user at the physical setting and including the at least one photograph of each user in the book.

8. The method of claim 7, wherein each user wears a different costume than the other users and wherein each costume represents a different character.

9. A method of making a customizable book, comprising:
having at least one user select a plot and at least one character that relates to the plot;
photographing the at least one user at a physical setting that relates to the plot and the at least one character;
obtaining at least one photograph of the at least one user wearing a costume at the physical setting; and
combining the plot and the at least one photograph to produce a customized book comprising text and the at least one photograph;
wherein the text comprises the plot.

10. The method of claim 9, wherein the costume represents the at least one character.

11. The method of claim 9, wherein the at least one user comprises multiple users.

12. The method of claim 11, wherein each user wears a costume representing an individual character, wherein each individual character is different from the other.

13. The method of claim 9, further comprising providing the at least one user with a guided tour of at least a part of the physical setting.

14. The method of claim 13, wherein the guided tour comprises a tour guide giving instructions to the at least one user to guide the at least one user to predetermined sections of the physical setting.

15. The method of claim 14, wherein the photograph of the at least one user is taken at at least one of the predetermined sections of the physical setting.

16. The method of claim 9, wherein the customized book is given to the at least one user at the physical setting after completion of the guided tour.

17. A method of conducting an interactive tour resulting in a customizable book, comprising:
providing a plot and a physical setting;
having at least one user select at least one character that relates to the plot;
having the at least one user wear a costume;
guiding the at least one user through the physical setting;
photographing the at least one user at predetermined locations along the physical setting that relates to the plot and the at least one character;
obtaining at least one photograph of the user at the physical setting; and
combining the plot and the at least one photograph to produce a customized book comprising text and the at least one photograph;
wherein the text comprises the plot.

18. The method of claim 17, wherein the guiding of the at least one user comprises a narration of at least a portion of the plot wherein the narration guides the at least one user to at least one predetermined location to be photographed.

19. The method of claim 17, wherein the at least one user is wearing a costume representing the character.

20. The method of claim 17, wherein the at least one user selects the arrangement of the text and the at least one photograph in the customized book prior to producing the customized book.
